(19) United States
(12) Patent Application Publication
(10) Pub. No.: US 2004/0013066 A1
(43) Pub. Date: Jan. 22, 2004

(54) Unbalance disc detection apparatus and unbalance disc detection method

(75) Inventors: Kenichi Oono, Saitama (JP); Keiji Ogura, Saitama (JP); Ryo Harada, Saitama (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/618,692

(22) Filed: Jul. 15, 2003

(30) Foreign Application Priority Data
Jul. 22, 2002 (JP) P2002-212146

(51) Int. Cl. G11B 7/00

(52) U.S. Cl. 369/53.14

(57) ABSTRACT

An unbalance disc detection apparatus with a photodetector for receiving at its photo reception region reflection light from a disc on which a laser light is irradiated, and a push-pull signal calculation section for obtaining a change of a light quantity detected by the photo reception region as a push-pull signal, whereby an unbalance disc discriminating section discriminates whether or not a level of the push-pull signal exceeds a threshold value set in correspondence to a predetermined measurement rotation speed.

### CROSS REFERENCE OF RELATED APPLICATION

This application is based on and claims priority with respect to Japanese Patent Application No. 2002-212146 filed on Jul. 22, 2002, the entire content of which is incorporated herein by reference.

### BACKGROUND OF THE INVENTION

1. Field of the Invention

The present invention relates to an unbalance disc detection apparatus and an unbalance disc detection method for detecting unbalance of a disc.

2. Description of the Related Art

An optical type disc drive apparatus such as a CR-ROM drive apparatus and a DVD-ROM drive apparatus requires a tracking servo system for controlling a reading laser light spot in the radial direction of a disc so that the spot accurately traces on a track of a pit sequence in order to accurately read pit information on the disc. According to such a tracking servo system, a deviation of the spot in the radial direction of the disc at the time of a tracking operation is detected as a tracking error signal based on a reflection light from the disc, and then a tracking actuator is driven by a driving voltage corresponding to a level of the tracking error signal thereby to continuously correct the spot so as to be positioned always at the center of a track.

Although a disc is rotated at a high speed in order to efficiently read data by using light, mass eccentricity of a disc exerts physically harmful influence on the operations of a tracking actuator, etc. Such an unbalance disc is generated due to non-coincidence between the center of a center hole and the center of gravity of the disc, and also generated in such cases, for example, that a picture or characters is printed on a disc or a seal is pasted on a disc.

However, if a disc is rotated at a high speed in such a mass eccentric state, vibration with a frequency corresponding to the rotation speed, so that harsh grating vibration sound is generated at the disc drive apparatus or the tracking servo can not be executed normally. As a result, there may cause a failure of the disc drive apparatus or the deformation or breakage of a disc. Thus, in the case of a disc with a large mass eccentricity, the generation of the aforesaid vibration is suppressed in such a manner that the rotation speed is reduced or the number of zero-crossing of the tracking error signal within a constant time period is detected thereby to detect an unbalance disc to suppress the vibration by utilizing the detection result.

FIG. 6 is a flowchart showing a conventional detection procedure of an unbalance disc. According to this procedure, first, a disc is placed on a turn table and chucked, and then driven at a predetermined rotation speed (step S1). In this case, since the tracking servo control is not performed, the tracking servo system is placed in an open (off) state (step S2) and the crossing number of the tracking error signal within a constant time period is measured (step S3). Then, when the crossing number is more than a set number (threshold), the disc is determined to be an unbalance disc (step S4), and so information is read at a low rotation speed (step S5). On the other hand, when the crossing number is equal to or less than the set number, the disc is determined to be a usable disc. Then, the detection processing of an unbalance disc is terminated and the process proceeds to an information reading procedure at a normal 40-times rotation speed, for example.

However, according to such a conventional unbalance disc detection method, since it is determined whether or not a disc is an unbalance disc in accordance with the crossing number of the tracking error signal within the constant time period, the determination is likely influenced by eccentricity of the mechanism or a disc, unbalance of a clamping state. Thus, the setting value (threshold value) of the crossing number is required to be set to a higher value in order to obtain an accepted efficiency with a standardized disc. As a result, there arises a problem that the detection accuracy of an unbalance disc is degraded.

FIG. 7 is an explanatory diagram showing a relation (rotation speed of 2,520 revolutions/min.) between the tracking error number crossing during one revolution and a threshold value L set with reference to the CD standard with an eccentricity of 70 μm, which was obtained through the experiments as to each of the standard disc, a disc with an eccentricity of 70 μm, a disc with an eccentricity of 140 μm, a disc with a mass eccentricity (unbalance) of 0.75 g·cm and a disc with a mass eccentricity of 11.0 g·cm. According to this relation, although the detection sensitivity of an unbalance disc is improved when the threshold value (T) of the tracking error number is reduced, the disc with an eccentricity of 70 μm is apt to be erroneously determined as an unbalance disc. In contrast, although the disc with an eccentricity of 70 μm is hardly determined erroneously as an unbalance disc when the threshold value of the tracking error number is raised, the detection accuracy of an unbalance disc is reduced to a large extent.

Further, when the swinging direction of the actuator caused by the vibration generated by the mass eccentricity of a disc coincides with the eccentric direction, the crossing number of the tracking error signal decreases. Thus, there arises a problem that an unbalance disc cannot be detected accurately.

Furthermore, since resonance frequencies or levels of the mechanism of respective portions change depending on the posture (horizontal or vertical) of the disc drive apparatus, there arises a problem that the detection can not be performed with a sufficient accuracy when the unbalance detection of a disc is performed at a constant rotation speed.

### SUMMARY OF THE INVENTION

The invention has been made to solve the above problems with the conventional art.

In order to attain the above object, according to one aspect of the invention, there is provided an unbalance disc detection apparatus comprising:

a photo detector which receives, at its photo reception region, reflection light from a disc on which a laser light is irradiated;

a push-pull signal calculation section which obtains change of a light quantity detected by the photo reception region as a push-pull signal;

a tracking drive control section which turns on and off a tracking drive mechanism for tracing, in a radial direction of the disc, an objective lens for projecting the reflection light of the laser light on the photo reception region; and

an unbalance disc discriminating section which discriminates whether or not a level of the push-pull signal exceeds a threshold value in an off-state of the tracking drive mechanism to discriminate an unbalance disc.

According to another aspect of the invention, there is provided an unbalance disc detection apparatus comprising:

driving a disc by a motor;

irradiating a laser light on the disc;

receiving the laser light reflected from the disc by a photo detector having a photo reception region;

obtaining change of a light quantity detected by the photo reception region as a push-pull signal in an off-state of a tracking drive mechanism for tracing, in a radial direction of the disc, an objective lens for projecting the reflection light of the laser light on the photo reception region; and

discriminating whether or not a level of the push-pull signal exceeds a threshold value to discriminate an unbalance disc.

### BRIEF DESCRIPTION OF THE DRAWINGS

These and other objects and advantages of this invention will become more fully apparent from the following detailed description taken with the accompanying drawings in which:

FIG. 1 is a block diagram showing an unbalance disc detection apparatus according to an embodiment of the invention;

FIG. 2 is a flowchart showing the execution procedure of the unbalance disc detection method according to the invention;

FIGS. 3A to 3C are timing charts showing level changes of push-pull signals as to various kinds of discs at the time of the motor rotation speed of 2,520 revolutions/min. in the invention;

FIGS. 4A to 4C are timing charts showing level changes of push-pull signals as to various kinds of discs at the time of the motor rotation speed of 3,120 revolutions/min. in the invention;

FIGS. 5A to 5C are explanatory diagrams showing a relation between a push-pull signal and threshold values in each of different placing manners of a disc drive apparatus in the invention;

FIG. 6 is a flowchart showing the detection procedure of the unbalance disc detection method according to the conventional tracking error detection; and

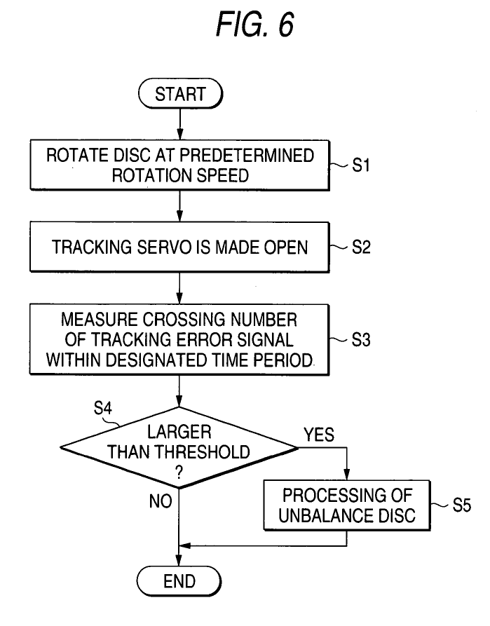

FIG. 7 is an explanatory diagram showing a relation between the conventional unbalance disc determination criteria and a tracking error number.

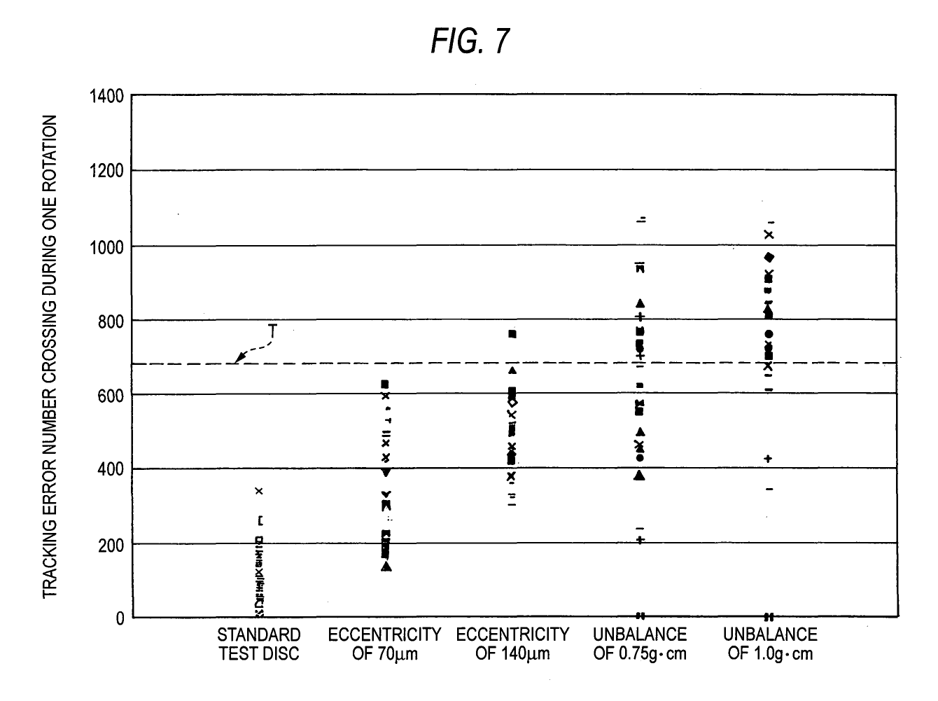

### DETAILED DESCRIPTION OF THE PREFERRED EMBODIMENTS

Hereinafter, a description will be given in more detail of an embodiment of the invention with reference to the accompanying drawings.

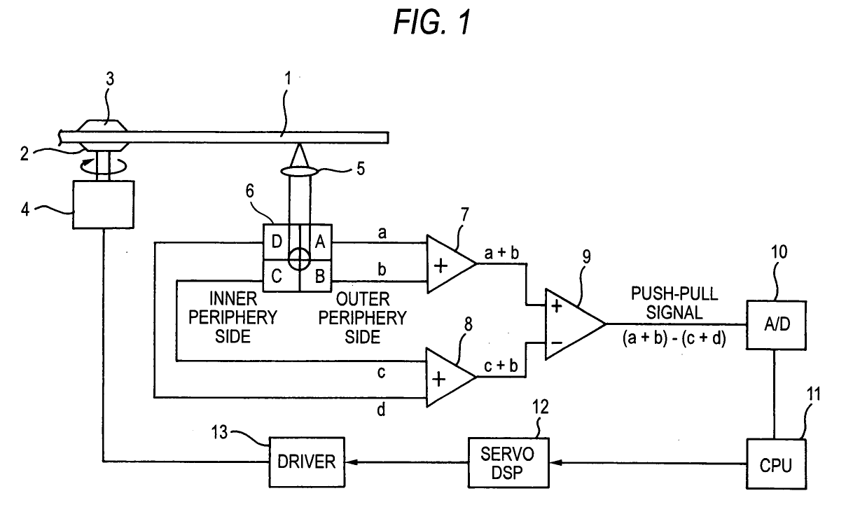

FIG. 1 is a block diagram showing an unbalance disc detection apparatus according to the invention. In FIG. 1, a reference numeral 1 depicts a disc such as a CD-ROM from which data is read optically. The disc is placed on a turn table 2 by a not-shown loading mechanism etc. In this placing state of the disc, the disc is chucked at its center hole by a chucking member 3 and so stably held on the turn table 2. The turn table 2 is driven so as to be rotated at a constant linear speed or a constant rotation speed by a motor 4 called as a spindle motor.

A reference numeral 5 depicts an objective lens serving as an optical pick-up means which is moved in the radial direction of the disc 1 by a not-shown disc drive apparatus disposed on the lower surface side of the disc 1 in an opposite manner thereto. The objective lens 5 has a function of projecting a reflection light from the disc 1 relating to alight (laser light) irradiated by a not-shown laser generator serving as an optical source on a photo detector described later. The objective lens 5 can move in both a tracking direction and a focus adjusting direction by a two axle or dual axis mechanism.

The photo detector 6 has four-divided photo reception regions A, B, C and D as shown in the drawing, each of which is disposed to detect a spot light and output a current according to the detected light quantity. An adder 7 is provided which is arranged to add signals a and b (that is, a+b) obtained from a pair of the photo reception regions A and B adjacent to each other in the tracking direction of these photo reception regions A, B, C and D. An adder 8 is provided which is arranged to add signals c and d (that is, c+d) obtained from the other pair of the photo reception regions C and D adjacent to each other in the tracking direction. Further, these adders 7 and 8 are coupled to a subtracter 9 serving as a push-pull signal calculation means which calculates a subtraction between the added signals supplied from these adders thereby to output a subtracted signal of (a+b)−(c+d) as a push-pull signal.

The subtracter 9 is coupled to an analog to digital converter (A/D) 10 which converts the push-pull signal into a digital signal capable of being calculated by a microprocessor 11 serving as an unbalance disc discriminating means. The microprocessor 11 calculates a mass eccentricity amount of the disc 1 based on a level of the push-pull signal. A reference numeral 12 depicts a servo digital signal processor (DSP) which sets a tracking amount by the dual axis mechanism of the not-shown disc drive apparatus or a servo amount with respect to the rotation speed of the motor 4 described later based on the mass eccentricity amount of the disc 1 during the tracking servo operation. A reference numeral 13 depicts a motor driver for supplying servo control data to the motor 4 thereby to drive the motor.

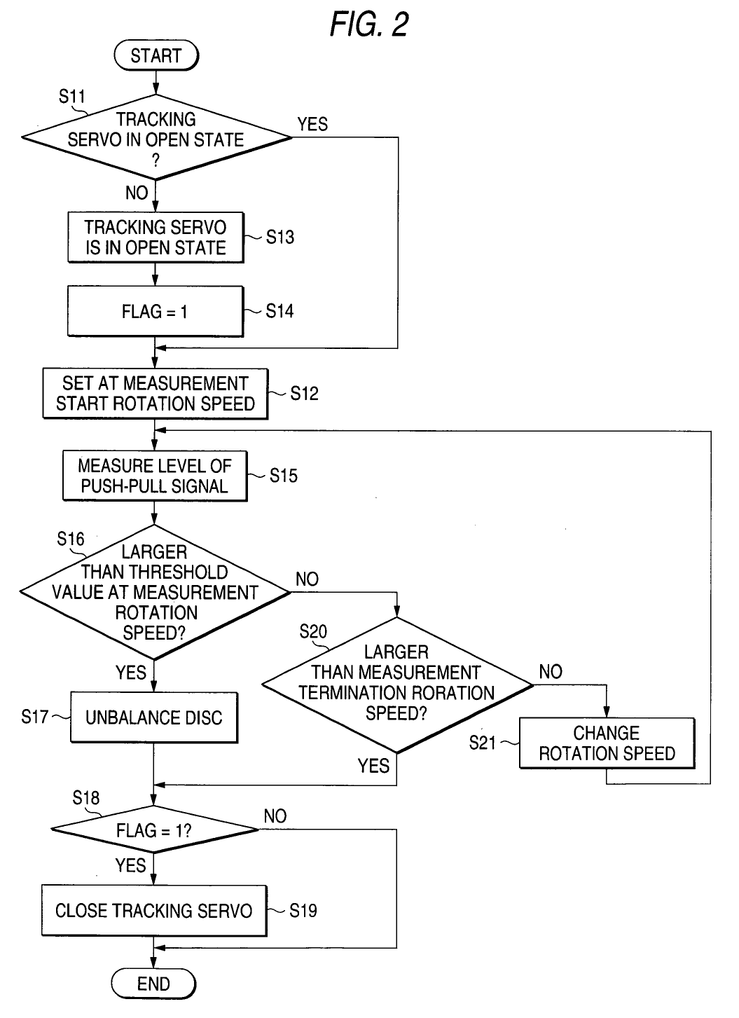

FIG. 2 is a flowchart showing the operation of the unbalance disc detection apparatus. First, the disc 1 is mounted on the turn table 2 of the disc drive apparatus, then the disc 1 is chucked with respect to the turn table 2 by the chucking member 3 and the motor 4 is driven and rotated at a low speed of 2,000 revolutions/min., for example. At this rotation speed, table of contents (TOC) information recorded at the tracks on the read-in area side of the disc 1 is read.

Succeedingly, it is checked whether or not a tracking servo system is in an open state (step S11). When the tracking servo system is in the open state, that is, in a stop state of the tracking servo control, the motor 4 is rotated at a measurement start rotation speed determined in advance, for example, 2, 520 revolutions/min. (that is, the rotation speed at which vibration likely occurs due to the resonance of a tracking actuator) in order to detect the mass eccentricity of the disc 1 (step S12). On the other hand, when the tracking servo system is not in the open state, the tracking servo system is forcedly opened thereby to stop the tracking servo control (step S13), then a flag for proceeding to the next processing is set (step S14) and the motor 4 is driven and rotated at 2,520 revolutions/min. (step S12). During this driving and rotation operation of the motor, the reflection light from the disc 1 is irradiated on the photo reception surface of the photo detector 6 thereby to obtain the signals a, b, c and d according to the received photo levels from the four-divided photo reception regions A, B, C and D, respectively. These signals a, b, c and d according to the received photo levels are inputted into the adders 7, 8, which in turn output an added signal a+b and an added signal c+d, respectively. These added signals are further inputted into the subtracter 9 and subjected to a subtraction processing to obtain the push-pull signal (a+b)−(c+d) (step S15). The push-pull signal is a signal representing a displacement state of the visual field position of the objective lens 5, that is, the mass eccentricity amount.

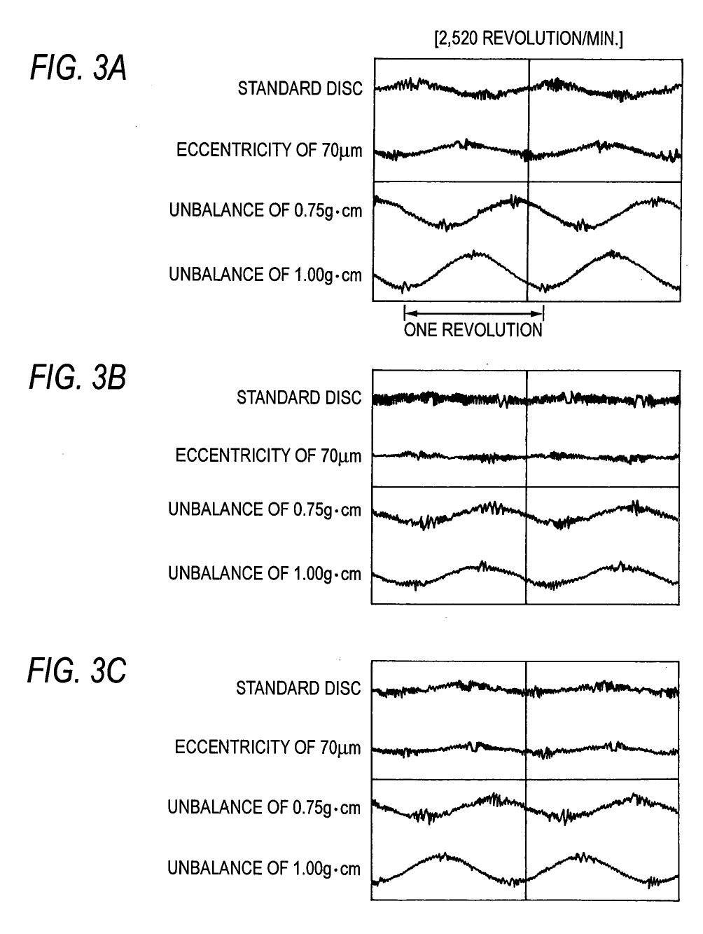

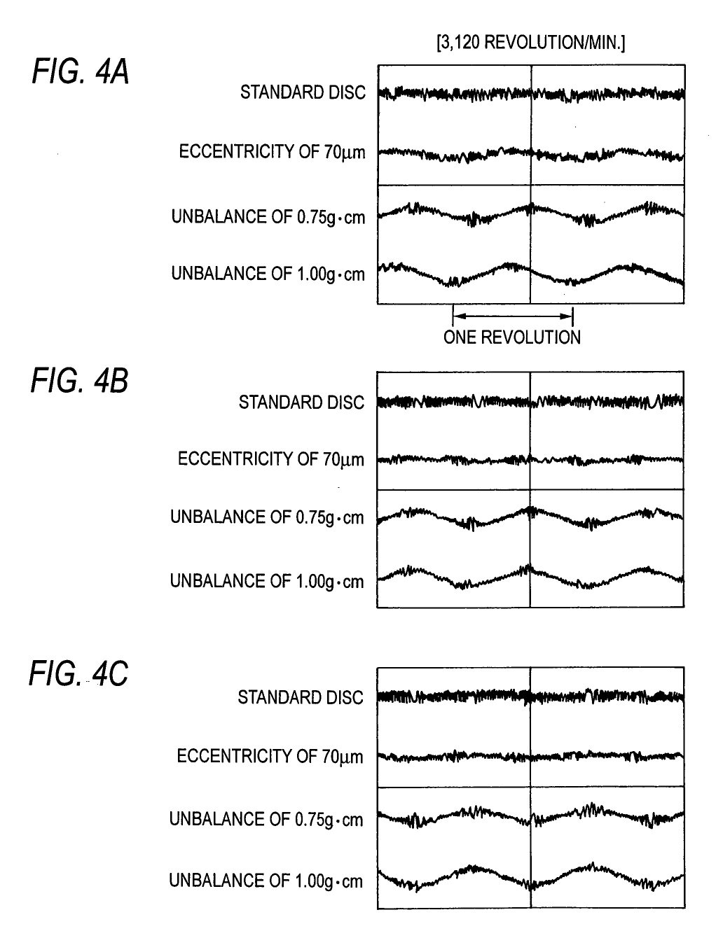

FIGS. 3A-3C and 4A-4C are graphs respectively at the rotation speeds of 2,520 revolutions/min. and 3,120 revolutions/min. of the motor 4, each representing level changes of the push-pull signals measured as to the standard disc, a disc with an eccentricity of 70 μm, a disc with an unbalance of 0.75 g·cm and a disc with an unbalance of 1.0 g·cm. FIGS. 3A and 4A show a case where the disc drive apparatus is placed horizontally, FIGS. 3B and 4B show a case where the disc drive apparatus is placed in a manner that its left side is down, and FIGS. 3C and 4C show a case where the disc drive apparatus is placed in a manner that its right side is down. Here, the rotation speed of 2,520 revolutions/min. is a rotation speed where the vibration likely occurs (that is, the rotation speed in the vicinity of the resonance point of the actuator).

According to those graphs, it will be understood that the push-pull signal of a large amplitude is measured at each of the disc with an unbalance of 0.75 g·cm and the disc with an unbalance of 1.0 g·cm irrespective of the rotation speed of the motor 4 and the placing manners of the disc drive apparatus. That is, the change of the vibration level of the tracking actuator can be measured as it is by measuring the push-pull signal. Then, the standard disc and the disc with an eccentricity of 70 μm can be discriminated from other unbalance discs based on the magnitude of the change of the amplitude. When the rotation speed is 2,500 revolutions/min., since the amplitude of the push-pull signal is large in each of the eccentric disc and the unbalance disc (particularly, when the disc drive apparatus is placed horizontally as shown in FIGS. 3A and 4A), it is difficult to discriminate between the eccentric disc and the unbalance disc depending on the posture of the disc drive apparatus. However, when the rotation speed is raised to 3,120 revolutions/min., since the rotation speed gets out of the vicinity of the resonance point and so the level of the push-pull signal of the eccentric disc becomes small, the eccentric disc and the unbalance disc can be discriminated easily to each other irrespective of the posture of the disc drive apparatus.

First, by utilizing the nature of the push-pull signal, it is checked as to the measurement start rotation speed (2, 520 revolutions/min.) whether or not the push-pull signal is larger than a preset threshold value for discriminating the unbalance disc (step S16). When it is determined that the push-pull signal is larger than the threshold value, it is determined that the disc is an unbalance disc (step S17). Thus, a flag representing the state of the tracking servo at the time of starting the measurement is checked (step S18), and when the flag is set at 1, the tracking servo is closed (step S19) and the discriminating processing of the unbalance disc at the rotation speed of 2,520 revolutions/min. is terminated.

On the other hand, when it is determined in step S16 that the level of the push-pull signal is equal to or smaller than the threshold value (T1), the process is branched into steps S20 and S21. In these steps, the rotation speed of the disc is changed and then a level of the push-pull signal is measured again (step S15). In step S15, it is checked whether or not the push-pull signal is larger than a preset threshold value (T2) which is different from the threshold value (T1). According to this embodiment, the threshold value is set to the value (T1) until the rotation speed is increased to 3,120 revolutions/min. In contrast, hereinafter, since a level of the push-pull signal of the eccentric disc becomes smaller, the threshold value is set to the value (T2) which is smaller than the threshold value (T1). Further, a measurement termination rotation speed determined at a step S20 is set to 3,600 revolutions/min. In the case where a level of the push-pull signal does not exceed the threshold level until the rotation speed reaches the measurement termination rotation speed, the disc is determined to be normal, and then the process proceeds to steps S18 and S19. In step S21, the rotation speed of the disc is increased step by step by a small rotation speed, for example, 120 revolutions/min. until the rotation speed reaches the measurement termination rotation speed.

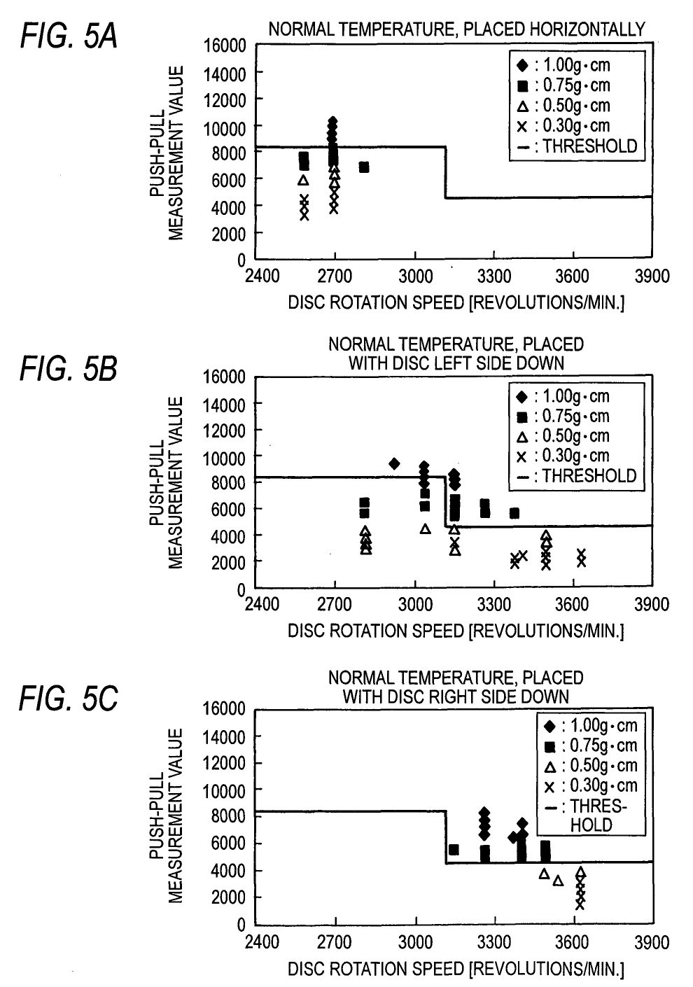

FIGS. 5A to 5C are explanatory diagrams, in the case where the disc drive apparatus is placed horizontally and placed in a manner that its left side is down and its right side is down, respectively, each showing a relation between eight measurement values of the push-pull signals as to disc rotation speeds and threshold values set at respective rotation speeds with respect to each of the respective discs with mass eccentricity of 0.3 g·cm, 0.5 g·cm, 0.75 g·cm and 11.0 g·cm. Here, the threshold value is set to a value near a level not reaching the push-pull signal of the disc with mass eccentricity of 0.5 g·cm. As a result, in this example, the threshold value is set such that its value changes at the rotation speed of 3,090 revolutions/min. Thus, the detection is made with threshold values different according to the rotation speed in a manner that the high threshold value and the low threshold value are used at the rotation speeds of 2,520 revolutions/min. and 3,120 revolutions/min., respectively.

Accordingly, in the case where the disc drive apparatus is placed horizontally, the unbalance discs with the mass eccentricity of 0.75 g·cm and 1.00 g·cm can be detected at the measurement start rotation speed of 2,520 revolutions/min. Also, in the case where the disc drive apparatus is placed in a manner that its left side is down, the unbalance discs with the mass eccentricity of 0.75 g·cm and 1.00 g·cm can be detected at the measurement start rotation speed of 2,520 revolutions/min and at the measurement termination rotation speed of 3,120 revolutions/min. Further, in the case where the disc drive apparatus is placed in a manner that its right side is down, the unbalance discs with the mass eccentricity of 0.75 g·cm and 11.0 g·cm can be detected at the rotation speed of 3,120 revolutions/min or more. The level of the measurement value (push-pull measurement value) of the push-pull signal is represented by a unit which is normalized based on the reflection factor of the disc and an incident light quantity to the disc etc. In this manner, since the push-pull signal is measured while changing the rotation speed of the motor 4 and the threshold value is changed according to the rotation speed for the measurement, an unbalance disc can be detected irrespective of the placing manner (posture) of the disc drive apparatus.

As described above, according to the embodiment, there is provided with the photo detector which receives, at its photo reception region, reflection light from a disc which is driven by the motor and on which a laser light is irradiated; the push-pull signal calculation means which obtains change of a light quantity detected by the photo reception region as the push-pull signal; the tracking drive control means which turns on and off the tracking drive mechanism for tracing, in the radial direction of the disc, the objective lens for projecting the reflection light of the laser light on the photo reception region; and the unbalance disc discriminating means which discriminates whether or not a level of the push-pull signal exceeds a threshold value set in correspondence to the predetermined measurement rotation speed in an off-state of the tracking drive mechanism thereby to discriminate an unbalance disc. Thus, the vibration component of the disc drive apparatus including the photo detector portion due to the mass eccentricity of a disc can be detected with a high accuracy and the discrimination of an unbalance disc can be performed with reference to the predetermined threshold values without being influenced by mass eccentricity of the disc.

Further, the unbalance disc is discriminated with reference to the threshold value which is changed in accordance with the measurement rotation speed. Thus, since the threshold value is changed according to the rotation speed for the measurement, an unbalance disc can be detected optimally according to the posture of the disc drive apparatus.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An unbalance disc detection apparatus comprising:
a photo detector which receives, at its photo reception region, reflection light from a disc on which a laser light is irradiated;
a push-pull signal calculation section which obtains change of a light quantity detected by the photo reception region as a push-pull signal;
a tracking drive control section which turns on and off a tracking drive mechanism for tracing, in a radial direction of the disc, an objective lens for projecting the reflection light of the laser light on the photo reception region; and
an unbalance disc discriminating section which discriminates whether or not a level of the push-pull signal exceeds a threshold value in an off-state of the tracking drive mechanism to discriminate an unbalance disc.

2. The unbalance disc detection apparatus according to claim 1, wherein the unbalance disc is discriminated with reference to a threshold value which is changed in accordance with the measurement rotation speed.

3. The unbalance disc detection apparatus according to claim 1, wherein the disc is driven by a motor.

4. The unbalance disc detection apparatus according to claim 1, wherein the threshold value is set in correspondence to a predetermined measurement rotation speed.

5. An unbalance disc detection method comprising:
irradiating a laser light on the disc;
receiving the laser light reflected from the disc by a photo detector having a photo reception region;
obtaining change of a light quantity detected by the photo reception region as a push-pull signal in an off-state of a tracking drive mechanism for tracing, in a radial direction of the disc, an objective lens for projecting the reflection light of the laser light on the photo reception region; and
discriminating whether or not a level of the push-pull signal exceeds a threshold value to discriminate an unbalance disc.

6. The unbalance disc detection method according to claim 5, wherein when a level of the push-pull signal does not exceed the threshold value, a measurement rotation speed is updated and the unbalance disc is discriminated with reference to a threshold value set according to the updated measurement rotation speed.

7. The unbalance disc detection method according to claim 4, further comprising driving the disc by a motor.

8. The unbalance disc detection method according to claim 4, wherein the threshold value is set in correspondence to a predetermined measurement rotation speed.
